(19) United States
(12) Patent Application Publication
(10) Pub. No.: US 2008/0294629 A1
(43) Pub. Date: Nov. 27, 2008

(54) PROCESS FOR FACILITATING A TELEPHONE-BASED SEARCH

(75) Inventors: Shlomo Gonen, Calabasas, CA (US); David Gonen, Calabasas, CA (US)

Correspondence Address: KELLY LOWRY & KELLEY, LLP, 6320 CANOGA AVENUE, SUITE 1650, WOODLAND HILLS, CA, 91367, US

(73) Assignee: METRO ENTERPRISES, INC., Beverly Hills, CA (US)

(21) Appl. No.: 12/123,762

(22) Filed: May 20, 2008

Related U.S. Application Data
(60) Provisional application No. 60/939,388, filed on May 22, 2007.

(51) Int. Cl. G06F 17/30

(52) U.S. Cl. 707/5; 707/E17.108

(57) ABSTRACT

The process for facilitating a telephone-based search includes accepting a telephone inquiry, receiving search criteria through the telephone inquiry and searching an electronic database for information relevant to the search criteria. A portion of the search criteria may be received from a software application installed on a telephone. Such search criteria may include a keyword or a category. Next, a search result relating to the search criteria is conveyed in response to the search inquiry. The search result should include a searchable category, a third party or a list of selectable third parties. Accordingly, the telephone inquiry is routed to a third party associated with the search result.

### BACKGROUND OF THE INVENTION

The present invention generally relates to a process for facilitating a telephone-based search. More particularly, the present invention relates to a process for facilitating a telephone-based search wherein a consumer is routed to a provider associated with search criteria submitted by the consumer through the telephone.

Consumers endeavoring to acquire goods or services must first find a company or individual that offers the desired goods or services. Traditionally, consumers peruse telephone directories, listing service medium, newspaper advertisements, or other comparable communication media to find the desired goods or services. Consumers typically seek goods or services that fit a relatively specific set of criteria. For example, a consumer may want to employ a provider having a certain skill set. A listing directory, such as bound paper phone books or other electronic directories usually do not provide detailed information about the provider other than name and contact information. Without other information, consumers blindly select a provider from an otherwise long list of potential service provider candidates.

After selection, the consumer calls the service provider. The consumer and service provider are immediately connected if the service provider is available. If the service provider is busy, e.g. servicing another consumer, the consumer may leave a message with the service provider. The consumer may then wait for a return phone call from the service provider. Alternatively, the consumer may blindly call a second service provider on the list. The consumer may repeat this process until the consumer either directly contacts a service provider or receives a return phone call from a previously called service provider. If this process is repeated several times, the consumer will receive multiple return phone calls from multiple service providers. Finding a service provider is particularly frustrating and time consuming when service providers are not immediately available. Furthermore, consumers are not able to acquire meaningful information from the listing directory before calling the service provider.

Consumers are increasingly searching for goods and services through internet search engines such as Google, Yahoo!, and eBay as more consumers purchase computers and obtain internet access. The availability of web-based search engines and listing directories somewhat lessens the time required to otherwise thumb through bound paper telephone books, traditional listing directories, or product catalogs. In response, companies and individuals are increasingly placing information on the Internet. Hosting a web site is particularly conducive to convey valuable information regarding company services, products, and contact information, such as a telephone number or email address, to the consumer via the Internet. For example, a consumer could search for “Spanish restaurants” through a popular internet search engine such as Google. Google displays a series of clickable links that match the search criteria. Consumers can visit various Spanish restaurant web sites for service, product, and contact information via clickable links on the search results page. One disadvantage is that the search engine may return several hundred results matching “Spanish restaurants”. The accuracy of the search results varies considerably depending on the search. In the example above, the “Spanish restaurants” search results should probably geographically coincide with the location of the consumer. Results not within the consumer's locale do not benefit the consumer or the listed restaurant. The consumer is required to spend more time thereafter to find a suitable Spanish restaurant.

Alternatively, companies and individuals (collectively “advertisers”) may subscribe to performance-based advertising plans offered by internet search engines. Advertisers pay for measurable events resulting from advertisements viewed by consumers. In paid inclusion advertising, an internet search engine displays an advertisement in response to specific keyword search. Each advertisement “click” from the search engine results page is the measurable event. This method of advertising is called “pay-per-click”. Advertisers pay the hosting search engine company, such as Google, a predetermined fee per consumer “click”. The “click” links the consumer directly to the advertiser's web site. Consumers may “click” on several web sites listed on the search results page before initiating contact with a specific advertiser. The advertiser benefits from the pay-per-click advertising plan by only paying for consumer “clicks”. In essence, the advertiser does not pay for advertising unless consumers actually view the advertiser's web site. Hence, fees associated with advertising are directly associated with the amount of web site traffic.

Advertisers do not necessarily retain consumer business from a “click”. There are many undeterminable circumstances that factor into whether an advertiser actually acquires business from a “click”. In most circumstances, these factors vary considerably by consumer. Obtaining business from a “click” usually requires that the consumer actually contact the advertiser. Contact may be initiated via a telephone call or another form of communication.

Paid placement advertising is another form of performance-based advertising. Paid placement advertising is similar to pay inclusion or “pay-per-click” advertising. Advertisers are billed on a per click basis. But, paid placement advertising displays company advertisements according to certain criteria. The criteria determines the ranking, order, or placement of advertisements on web pages. For example, the highest bidding advertiser may have an advertisement prominently placed at the top of a search engine results page. In theory, the odds are greater that a consumer will “click” on the prominently displayed advertisement relative to other less prominently displayed advertisements on the same web page.

Both paid placement and paid inclusion performance-based advertising methods are suitable plans for advertisers that have an internet presence, i.e., conduct e-business or maintain web sites where consumers purchase products or research business information. But, millions of companies and individuals do not have an internet presence. Approximately seventy percent (70%) of businesses do not have active web sites or even a presence on the Internet. Furthermore, those companies or individuals that do have an internet presence may ineffectively capture a potential consumer by providing inadequate information. These companies and individuals may be unable or even unwilling to participate in such performance-based advertising.

Additionally, searching for goods or services on-line has several disadvantages. First, consumers must conduct the appropriate search through an internet search engine. This assumes the consumer is computer savvy and has an internet connection. Second, the consumer must select the “best” company or individual from the list of results. Absent actually researching and reading comparative web sites, this selection method is almost no different than the blind service provider selection previously described. Consumer selection criteria may include products, geographic location, reputation, services, etc. Researching even a few web sites from a large list of search results is laborious and time consuming in itself.

Internet based pay-per-call routing systems enable consumers to more accurately locate companies and products according to a wide variety of criteria including price, service, location, rating, etc. Such routing systems facilitate the connection of real-time communication between consumers and advertisers. Consumers can immediately contract with an advertiser for services through the Internet or telephone. For example, a consumer searches for a doctor through an internet search engine. The consumer is able to contact the doctor directly from the search results page. The doctor may offer instant consultation for $2.00 per minute or for $100.00 for a one hour session. The consumer may accept the doctor's contract offer or contact another doctor from the search engine results page. The search results page may also include a real-time availability indicator to notify the consumer that the doctor is ready to perform a consultation. The consumer can directly connect to the doctor by clicking a link that initiates a telephone call, video chat, or other communication session. The consumer receives the consultation and pays the doctor directly.

A similar pay-per-call system that routes telephone calls from consumers to service providers is disclosed in U.S. Pat. No. 6,704,403. Here, service providers register with a web site to advertise a business name and telephone number on the Internet. Typically the service provider has a unique toll free (800) number or other local contact number. Consumers select from a relatively short list of potential service providers after conducting an internet search. The consumer is then automatically routed directly to a specific service provider via a telephone call. The consumer leaves a message if a service provider representative is unavailable. The service provider pays a predetermined flat fee for each call received. Similar to the performance-based advertising methods described above, the service provider pays the web site search engine to route telephone calls to the service provider. Contact with the consumer is not guaranteed if the service provider or representative is unavailable. But, the service provider does not need to maintain a web site or other internet presence to be accessible in the on-line searchable database of the '403 patent. Unavailability is the primary reason that consumers fail to establish a real-time communication link with a service provider.

The '403 patent has several drawbacks. First, the '403 patent still requires that the consumer have a computer and internet access. Second, the consumer must still search for a service provider via the Internet. The consumer cannot even start a search without internet access. Further, the consumer will not connect in real-time if the service provider is unavailable. Again, the consumer may leave a message and wait for a return telephone call. The consumer then has the option to call the next service provider on the list. While the '403 patent discloses technology that enables the service provider to easily return consumer phone calls, the consumer must still inevitably wait for the service provider to make the return telephone call. This is a tedious process, as previously described. Service providers are charged for receiving the phone call despite only receiving a message.

To enhance competition for services and efficiency of selling key-word advertising, bidding systems were incorporated into these internet-based telephone routing system search engines. Advertisers bid to have advertisements appear higher or before comparative competing advertisements. Alternative bidding systems combine this bidding mechanism with additional criteria, such as advertiser popularity or quality, when determining advertisement display order. Here, popularity and bid amount are both considered when ranking advertisements. But, bidding systems are also inefficient because advertisers are not always available. Advertisers that are busy or closed are unable to answer consumer telephone calls. If a search engine consistently displays the top bidding advertiser, there is a high likelihood that that advertiser will not always be available. Ultimately, the consumer does not immediately connect to an advertiser in real-time. The consumer must continue the search until obtaining real-time contact.

Pay-per-call systems are also configurable to dynamically route telephone-to-telephone based calls to available advertisers. U.S. Pat. No. 7,076,037 discloses such a dynamic call routing system. Here, companies are able to change availability. Availability status is conveyed to the consumer at some point during the search process. Additionally, the consumer is notified when a particular service provider is ready to deliver services. The service provider turns an indicator “on” when available to communicate with consumers. Under this system, service providers pay for real-time contacts with consumers. This system also avoids unwanted consumer contact during unavailability.

There are several major drawbacks to the advertising systems previously discussed. First, internet-based advertising requires that the consumer have a computer and internet access. Without internet access, the benefits of advertising and call routing are unrealized. Most notably, the consumer never connects to or speaks with a company representative or service provider. Second, it is difficult for advertisers to ascertain the source of referrals. Consumers may contact an advertiser via contact information obtained from any one of several sources. Correlating advertising expenses to actual successful referrals is a measurable asset for advertisers. The pay-per-click method employed by Google and other major search engines cannot provide this correlation. Pay-per-click cannot track actual consumer contact with the company after the “click”. Phone calls are one measurable contact event that enables advertisers to evaluate revenue per phone call generated verses advertising expenses. Thus, advertisers need a method of tracking business in relation to advertising expenses. Advertisements that fail to attract consumers are inefficient.

Accordingly, there is a need for a telephone-based search engine that can track real-time consumer and business contact. The search engine will enable consumers to search for a wide variety of goods or services via any telephonic device. Interconnection of the telephone search engine with an external telephone routing system enables real-time communication between consumers and providers. Further, the telephone search engine will enable consumers to conduct a categorical search for goods or services while disconnected from a telephone network. Moreover, the consumer can conduct an extensive search while connected to a broader searchable online database via a telephone network. A series of menus, voice commands, or other categorical search methods compatible with a telephone enable consumers to accurately and efficiently narrow search results to a specific category.

### SUMMARY OF THE INVENTION

The present invention is directed to a process for facilitating a telephone-based search. First, a telephone inquiry from a consumer endeavoring to search for a good and/or service over the telephone is received. A data connection is established with the consumer telephone over a telephone network for the exchange of data to facilitate the telephone-based search. The consumer provides search criteria through the telephone as a result of the telephone inquiry. The search criteria may be provided by voice, text message, SMS, DTMF, a search representative, a touch-tone or a software application on the telephone. In a particularly preferred embodiment, at least a portion of the search criteria is received from a software application installed on the consumer telephone.

Next, an electronic database is searched for information relevant to the search criteria. Search criteria typically includes a keyword or a category that can be used to narrow the scope of the search in the electronic database. In a particularly preferred embodiment of the present invention, at least a portion of the electronic database is stored on the consumer telephone and is searchable by the corresponding software application offline. A search result relating to the search criteria is conveyed to the consumer in response to the telephone inquiry. The search result may include a searchable category, a third party, or a list of selectable third parties. Such information may be conveyed to the consumer over the telephone by voice, text message or through the software application. In a particularly preferred embodiment, the list of selectable third parties provided in the search result are ranked according to a set of criteria. In one embodiment, the geographic location of the telephone inquiry is used to rank the list of selectable third parties based on the geographic location of the third parties relative to the location of the telephone inquiry. The list of selectable third parties may be re-ranked based on additional search criteria provided through the telephone inquiry. The consumer making the telephone inquiry is then routed to a third party associated with the search result. The third party may be automatically selected or selected by the consumer. Accordingly, the telephone inquiry is routed to the third party on-demand and in real-time.

Additionally, the process for facilitating a telephone-based search in accordance with the present invention may include updating the electronic database in real-time and establishing a universal access number for accepting the telephone inquiry. In a particularly preferred embodiment, the system queries the telephone to determine whether a search engine software application is installed thereon. The search engine software application may be transferred to the telephone when the telephone does not have the search engine software application installed thereon. Accordingly, the search engine software application is capable of facilitating at least a portion of the telephone-based search before connecting to the system of the present invention over a telephone network.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart that illustrates the general process of conducting a search via a telephone search engine of the present invention;

FIG. 2 is a flowchart that further illustrates the steps of acquiring telephone search engine access;

FIG. 3 is a sample flowchart highlighting the interconnectivity of potential menus and submenus within a telephone search engine software application of the present invention;

FIG. 4 is a sample flowchart of a potential celebrity search; and

FIG. 5 further illustrates a flowchart of sample online telephone search engine menus.

### DETAILED DESCRIPTION OF THE PREFERRED EMBODIMENTS

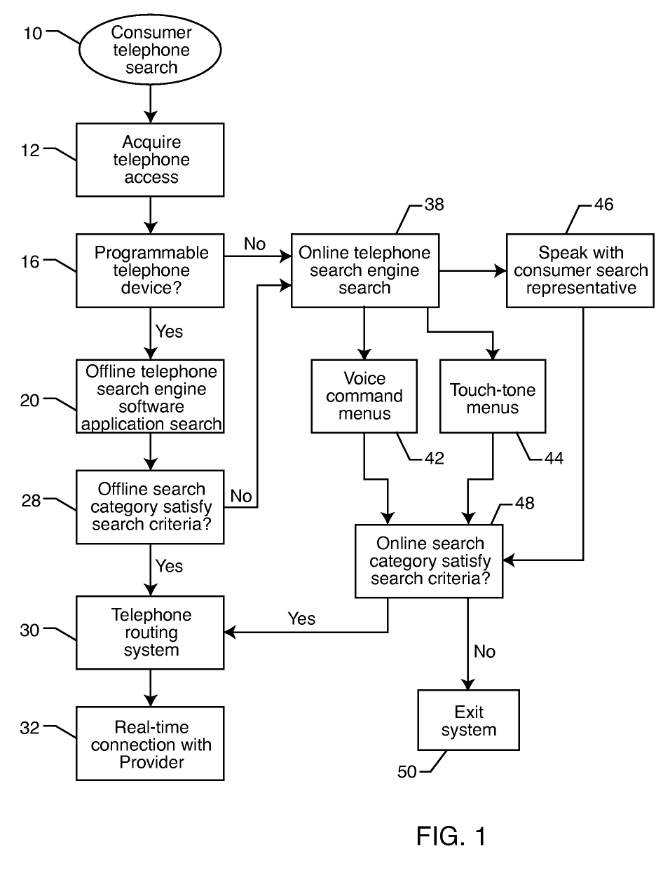

As shown in the exemplary drawings for purposes of illustration, the present disclosure for a process for facilitating a telephone-based search is referred to generally in the flowchart of FIG. 1. The telephone search engine of the present invention is used to efficiently interconnect persons in real-time via a telephone routing system. The real-time interpersonal connection is facilitated directly by the telephone routing system or other comparable system know in the art. A sample telephone routing system compatible with the present invention is disclosed in U.S. Pat. No. 7,076,037 to Gonen et al., herein incorporated by reference. The telephone search engine of the present invention provides a simple and convenient way for persons searching for any tangible or intangible goods or services offered by another person, company, government agency or other entity. The telephone search engine utilizes the basic functions of the telephone as a search engine. Traditional electronic search engines typically require internet access via a personal or business computer or other advanced telephonic device that has internet access and a web-browser installed thereon. The current invention simplifies and streamlines the searching process by eliminating the Internet. Consumers may conduct traditional internet search engine-based searches via the telephone with dual-tone multi-frequency (DTMF) signals, voice commands, touch-tone menus, or by directly communicating with a consumer search representative.

The scope of searchable items within the telephone search engine is virtually limitless. As an example, the telephone search engine encompasses services provided by the Yellow Pages, traditional paper bound telephone books, Smart Pages, paper and electronic advertising, dating services, product auctions, sale or leasing of goods and services, classified advertisements, etc. It will become apparent how this list is virtually endless. For example, a consumer may search for a specific telephone number stored in the telephone search engine. The telephone search engine then connects the consumer with the provider associated with that specific telephone number. In this example, the telephone search engine essentially acts as a calling card. In another example, a consumer may search for a specific entity within the telephone search engine, similar to a search within the Yellow Pages or White Pages. The telephone search engine will convey the contact information for the specific provider and convey that information to the consumer. In a particularly preferred embodiment, the telephone search engine connects the consumer with the provider.

The basic functionality of the telephone search engine is the ability to create an on-demand real-time connection between an entity searching for an item (which includes the wide array of goods and services) with a second entity selling or offering the item being searched. The telephone search engine includes a series of categorical menus that enable the searching entity to accurately narrow the search to a small group of entities selling or offering the desired item. This greatly enhances the quality of the lead connection between the two entities. This search occurs prior to connecting to a telephone network (“offline”) via telephone search engine software application or after connecting to a telephone network (going “online”).

For the purposes of this invention, the term “offline” specifically refers to telephone use while not connected to a telephone network. No air time or other measurable minutes chargeable by a telephone carrier are used. Furthermore, the term “online” references consumer contact to a telephone network via any one of the telephone devices described herein. Here, telephone companies may track per-minute air time usage or impose a per-minute fee depending on the consumer's telephone carrier plan. In a preferred embodiment, consumers may access the telephone network via an (800) or other toll free or local telephone number. Thus, the consumer is not charged for connecting to the telephone network (going “online”). The term “online” does not have any reference to an internet connection. The present invention does not require an internet connection. All data is transferred via a telephone network connection. Voice over internet protocol (VoIP) and WiMAX are considered within the scope of a telephone network connection of this invention.

The entity seeking a good or service as already broadly defined is herein referenced as a consumer. A consumer may include, but is not limited to, an individual person, a group, a company or other related business, government agency or department, or any other entity known in the art to search for or facilitate the search for some tangible or intangible, good, service, or virtually any other searchable item. The entity providing or selling the aforementioned items is herein referenced as the provider. The provider, like the consumer, may include, but is not limited to, an individual person, a group, a company or other related business, government agency or department, or any other entity known in the art to provide, offer to sell or lease, some tangible or intangible, good, service, or virtually any other searchable item known in the art. Searching for a provider or searching within a category of providers includes search results pertaining to both individual providers (e.g. a specific celebrity) and a plurality of potential providers (e.g. a group of hotels in a specified city). Often, more than one provider will offer an item searchable by the consumer. The plurality of providers may compete via a bidding system to vie for the real-time connection with the consumer. These types of search results and categories are also applicable for the broad array of items previously described. Sample embodiments of the real-time connection between the consumer and provider are further disclosed herein in detail.

FIG. 1 illustrates the general process for facilitating a real-time connection between the customer and the provider. First, the consumer must endeavor to search for an item. In the present invention, the consumer searches for this item via a consumer telephone search 10. Any telephone search engine search as broadly defined in the present invention, both online and offline, is generally referenced herein as “telephone search”. Next, the consumer must acquire telephone access 12. Acquiring telephone access 12 includes accessing a wide range of telephone devices, including, for example, cell phones, smart phones, Blackberry wireless devices, land lines (rotary and touch-tone), or any other telephonic communication device known in the art. The potential search capabilities of each telephone device ranges by the degree of technology incorporated into the device. For instance, a touch-tone telephone is not as technologically advanced as, for example, a smart phone. The touch-tone telephone may be as simple as a wired headset and corresponding 0-9 numbered keypad. The telephone search engine of the present invention is usable by the touch-tone telephone via voice communication, touch-tone dialing, or a consumer search representative. Consumers use a touch-tone telephone to connect to a telephone network by dialing an access number. Consumers need only one universal telephone access number to connect with the telephone search engine. Therefore, multiple telephone numbers are not required to connect with a wide variety of providers. Alternatively, consumers may send information to the telephone search engine concerning a selection or search prior to creating a telephone network connection. The telephone search engine, in turn, calls the telephone of the consumer. In this embodiment, the telephone network connection is initiated by the telephone search engine and not the consumer. After creating the telephone network connection, the consumer may select searchable categorical menus, through any of the methods disclosed herein, to narrow the search.

A smart phone, alternatively, has a variety of communication devices included therein. Typically, smart phones incorporate powerful software management tools such as spreadsheets, word processors, calendars, text-to-speech communication tools, text messaging, video messaging, video capture, voice communication, music players, and other home or office tools. Smart phones also have computer operating systems that facilitate and coordinate the different communication tools provided therein. Additionally, smart phones may include a QWERTY keyboard to better facilitate the use of text messaging, instant messaging, or the use of other communication or office applications. A smart phone can search the telephone search engine via one or more of the previously disclosed management tools, including the touch-tone telephone search methods previously described. Smart phones thus have a much wider variety of potential search functions relative to a touch-tone telephone.

After acquiring telephone access 12, the consumer must ascertain whether the telephone device has an offline telephone search engine software application (hereinafter “software application”) installed therein. The basis of the telephone search engine is to provide an easy and convenient way for consumers to connect with a specific provider in real-time via a telephone network. In one embodiment of the present invention, the software application is installed on the telephone device to facilitate offline searching. Consumers may search for the variety of items or providers as previously described while offline. Thus, the consumer can peruse a wide range of searchable categories while not using telephone air time. No internet connection is needed to conduct the search with the software application.

The software application contains a plurality of selectable menus and submenus. The potential arrangement, combination and interconnection of the menus and submenus are essentially limitless. Although, for design considerations such as compatibility, the telephone search engine software application is preferably lightweight in size. In a particularly preferred embodiment, the overall size of the software application is less than one hundred kilobytes. A lightweight software application is simply designed and easy to use. Although, any size software application may be used with the present invention pending the size does not exceed the amount of available resources within the telephone device. Multiple software applications of various sizes may be available depending on the capabilities and available resources of the relevant telephone device. Accordingly, more telephone devices are compatible with smaller software applications.

The lightweight menus and submenus remove any need for an internet connection, web browser, or other internet related tools. In fact, the present invention completely eliminates any need for the consumer to have internet access to conduct a search. Moreover, the software application has search capabilities comparable to larger internet search engines such as Google and Yahoo!. But, the software application is significantly smaller in size and easier to use. The menus and submenus streamline the real-time consumer to provider connection process. Consumers no longer need to dial separate telephone numbers after finding multiple suitable providers via an internet search. Consumers narrow search results by selecting a list of desired criteria associated with the menus and submenus. Offline searching via the menus and submenus reduces consumer air time usage. Consumers can peruse the various searchable categories at leisure without incurring air time charges. Cell phone consumers and consumers that pay-per-minute of air time save valuable and potentially chargeable minutes. Furthermore, the consumer spends more time choosing an accurate category that satisfies the desired search criteria. Of course, searching for an accurate category, while offline, is free. The software application connects to the telephone network, i.e., goes “online”, once the consumer selects a desirable search category. Thereafter, the consumer is connected to a telephone routing system for eventual real-time connection with a provider.

The software application overcomes several deficiencies in the art. For instance, current telephone-to-web internet search engines have a series of requirements that limit consumer use. First, the limitations of the telephone device must be considered. For example, traditional touch-tone telephones are unable to connect to the Internet. A person can not conduct an internet search with only a touch-tone telephone. Second, telephone devices that can connect to the internet must have special internet enabled browsers installed therein. Internet browsers typically require several megabytes for installation. The software application of the present application requires less than one hundred kilobytes, or approximately one-tenth the size of an internet browser. Additionally, not all internet search engines are compatible with these special Internet browsers. Third, the consumer must have internet service. Consumers typically must add an additional internet line (or other data transmission package) to an existing cellular phone service, cable internet, or DSL phone package, for an added cost. This added cost may more than double the original bill. Without the Internet, consumers are unable to conduct telephone-to-web searching through a web-browser enabled internet-based search engine, such as Google.

The software application of the present invention solves the above deficiencies and provides further related advantages. First, the telephone search engine of the present invention does not necessarily require installation of the software application, as explained in more detail below. Virtually any telephone device capable of connecting to a telephone network is compatible with the telephone search engine of the present invention. Second, the software application preferably uses less than one hundred kilobytes for installation. Thus, the software application is more compatible with a wider range of devices compared to major web browsers, like Internet Explorer and Fire Fox, that require multiple megabytes for installation. Third, an internet connection is not required. Searching is conducted completely over a telephone network connection. Most notably, the software application allows users to search categories through a series of offline menus and submenus. The software application may be written in JAVA or another computer programming language known in the art. Alternatively, a search can be conducted online via the software application over a telephone network connection. A series of menus and submenus are accordingly available online. When online, the software application is not necessarily needed but could still be used.

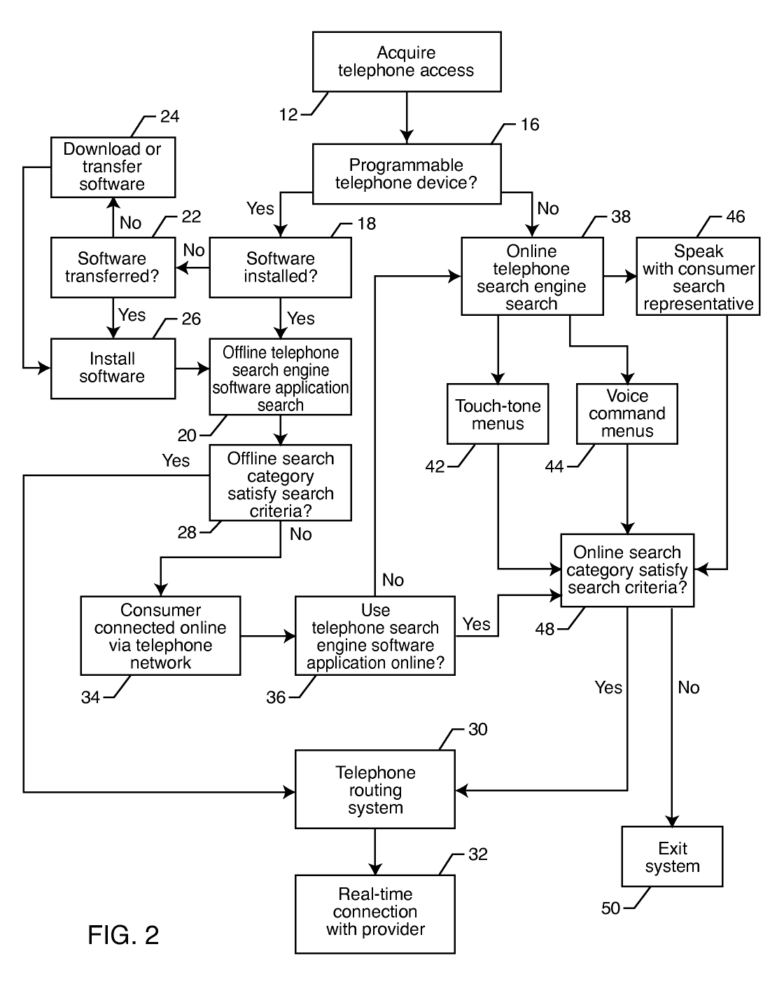

FIG. 2 illustrates a flowchart wherein the consumer acquires telephone access 12 for conducting either an online or an offline telephone search. First, the consumer must determine whether the accessed telephone is a programmable telephone device 16. Installation of the software application requires a programmable telephone device 16. But, a programmable telephone device 16 is not required to conduct a telephone search as described herein.

During a software installation step 18, the consumer determines whether the programmable telephone 16 has the software application installed thereon. A programmable telephone device 16, such as a cell phone or smart phone, may have the software application pre-installed by the manufacturer or by the telephone carrier. In this embodiment, the consumer can immediately move to an offline telephone search 20. Alternatively, when the software application is not pre-installed, the consumer must determine whether the software application is stored on the telephone device 16 during a software transfer determination step 22. After market transfer or download 24 of the software application to the telephone device 16 may be necessary before installation is possible. In one embodiment, wireless telephone carriers such as Verizon Wireless, AT&T, or T-Mobile may allow users to selectively download 24 the software application post-manufacture. Alternatively, a consumer or other third party, such as a cell phone refurbishing company or a third party vendor, may selectively transfer 24 the software application to the memory of the programmable telephone device 16. Transfer 24 can occur via USB, fire wire, infrared (IR), Ethernet, blue tooth, or any other transfer device know in the art. The software application could be transferred from a number of different devices, including, but not limited to, computers, USB storage drives, portable hard drives, PDA or other non-telephonic devices, other telephonic devices, or any other storage medium known in the art.

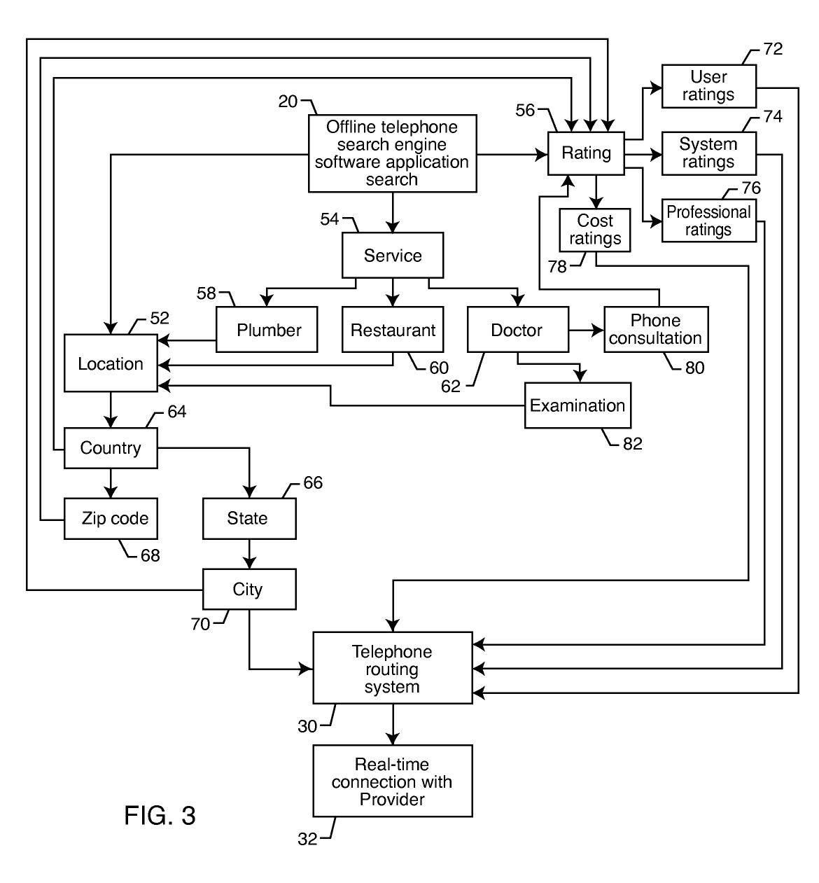

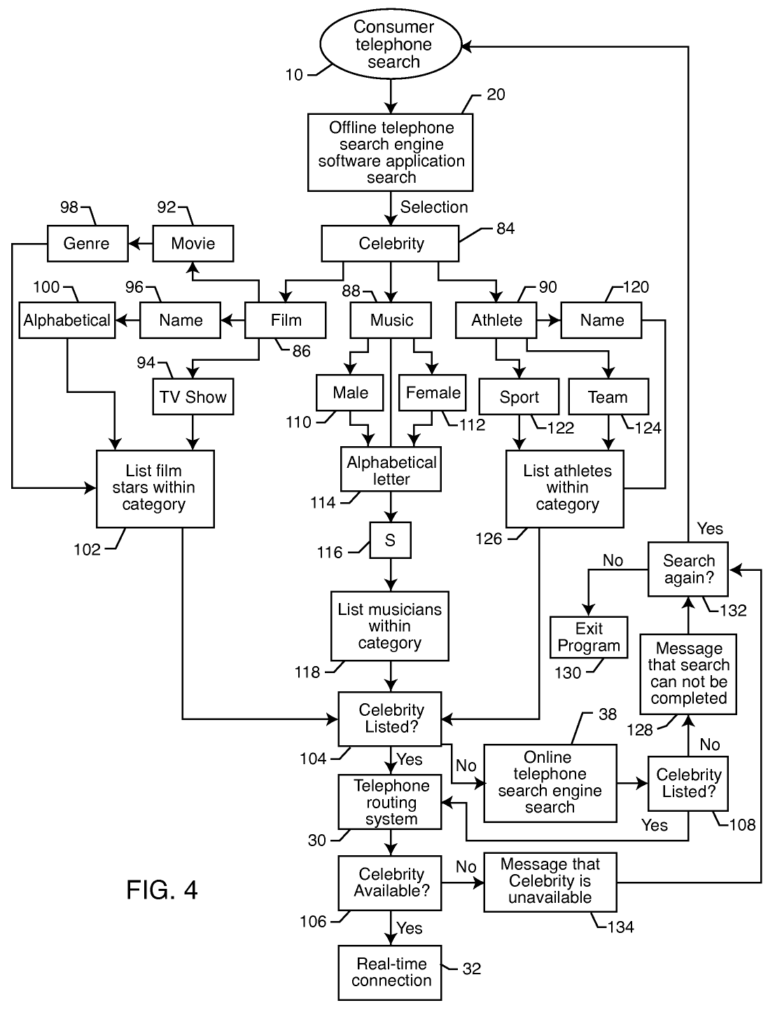

Once the download or transfer 24 is complete, the software application is installed 26. No other special software is required for installation 26. After installation 26, the consumer may conduct an offline telephone search 20 via the menus, submenus, and any other search option or criteria incorporated into the telephone search engine of the present invention. The consumer selects from a variety of specific searchable categories via the menus and submenus. Category selection is based on consumer search criteria. One example of the interconnectivity of various menus and submenus of the software application is highlighted in FIG. 3. Furthermore, FIG. 4 illustrates a specific menu search for a celebrity.

With reference back to FIG. 2, in one embodiment the consumer adequately reaches an offline search category 28 that satisfies the search criteria. Here, the software application goes online and connects the consumer to a telephone routing system 30. The software application provides the telephone routing system 30 with the necessary information to create a real-time connection with a provider 32 within the scope of the telephone search criteria. The details of a sample telephone routing system 30 is disclosed in U.S. Pat. No. 7,076,037, herein incorporated by reference. Alternatively, the telephone routing system 30 simply provides the consumer with a list of potential providers instead of automatically creating the real-time connection according to the methods in the '037 patent. Accordingly, the consumer selects a specific provider from the list of providers generated by the telephone search engine of the present invention. Thereafter, the real-time connection with a provider is created.

The software application communicates with the telephone routing system 30 via several methods, after creating a telephone network connection thereto. The software application may communicate with the telephone routing system 30 via a series of DTMF signals (thereafter receiving a callback from the telephone routing system 30), accelerated over audio DTMF signals generated by the software application instead of the telephone carrier, an ISDN User Part (ISUP) message or equivalent caller identification, compressed text over audio using a BELL 202 modem for streamline data transfer, text over the Internet to maintain a real-time conversation or receive a callback, a telephone network connection over the Internet, speech recognition or DTMF (no covert communication), fax tones (thereafter receiving a callback), or a text-to-speech recognition system (such that a conversation may continue without interruption). The software application can exchange electronic information via any of the above methods without interrupting a conversation. The above-described methods of communicating between the software application and the telephone routing system 30 of the present invention are merely preferred embodiments and are not meant to be a finite list of capabilities.

Alternatively, the offline search category 28 may not satisfy the search criteria. Here, the software application creates a telephone network connection 34 to facilitate a more extensive online telephone search. The consumer may choose to conduct an online software application search 36 with an expanded set of menus and submenus available online. Alternatively, the consumer may choose to conduct the expanded search via an online telephone search 38 also having an extensive list of searchable categories. The consumer is connected directly to the telephone routing system 30 if the consumer finds a suitable searchable category after conducting the online software application search 36. Alternatively, if the consumer does not find a suitable searchable category, the consumer may choose to speak with a consumer search representative, to search over or exit the system.

The online software application search 36 provides accesses to an extensive set of categories otherwise potentially not available for the offline telephone search 20. Data transfer to the software application concerning the online menu system is streamlined and measured in kilobytes, not megabytes. Thereafter, the telephone routing system 30 facilitates the real-time connection with a provider 32.

Alternatively, the consumer may choose not to continue using the software application. In this embodiment, the consumer may continue searching using the online telephone search 38. The consumer continues searching using the voice command menus 42, touch-tone menus 44, or by communicating with a consumer search representative 46. If the online search category 48 satisfies the search criteria, then the consumer is connected to the telephone routing system 30 for eventual real-time connection with a provider 32. Otherwise, the consumer is prompted to exit the system 50 or start a new search (not shown). The voice command menus 42, touch-tone menus 44, and consumer search representative 46 are described in more detail below.

In another alternative embodiment, the consumer may not have a programmable telephone device 16. Here, consumers may immediately conduct the online telephone search 38 via the touch-tone menus 44, the voice command menus 42, or by communicating with the consumer search representative 46. The consumer also has the option of conducting the online telephone search 38 immediately despite having a programmable telephone device 16. Here, the consumer chooses to bypass a potential offline telephone search 20 altogether. The online telephone search 38 includes a larger set of menus and submenus relative to the offline telephone search 20. Potential search results are also greater compared to the offline telephone search 20 because the online telephone search 38 is not as size sensitive as the software application. Additionally, the online telephone search 38 is updated in real-time as providers and items are added and removed from the system. But, the software application is adequate for most category or provider searches.

FIG. 3 further illustrates a brief flowchart highlighting a sample set of interconnected menus and submenus incorporated with the software application of the present invention. FIG. 3 is merely a sample embodiment. The general flow concept embodied in FIG. 3 is also suitable for facilitating an online or offline telephone search via any of the methods previously described. The different combinations and interconnections of menus suitable for telephone searching is virtually limitless.

In the example of FIG. 3, three main menus are included as part of the initial offline telephone search 20. These three menus are used for this example only. The number and category of menus may vary by application. The menus shown include (1) a Location menu 52, (2) a Service menu 54, and (3) a Rating menu 56. Each of these menus may be interconnected, as shown in FIG. 3, or separate as independent branches as generally shown in FIG. 4. Most importantly, all branches eventually lead the consumer to the telephone routing system 30 and a real-time connection with a provider 32 after a searchable category is reached. A system exit option (not shown in FIG. 3) is available to the consumer if a suitable category is unavailable. In one sample embodiment, a consumer selects the Service menu 54 within the software application. The submenus appearing beneath the Service menu 54 may include the Plumber submenu 58, the Restaurant submenu 60, or the Doctor submenu 62, as shown. The three sample submenus are used to further narrow the scope of the telephone search. For instance, the Restaurant submenu 60 may include selection of Spanish, Japanese, American, Italian, or any other type of cuisine. After cuisine selection, the consumer may have the option of choosing a location of individual restaurants. In this embodiment, the Location menu 52 is both a main menu and submenu as interconnected with the Service menu 54 via the Restaurant submenu 60. The Location menu 52 is especially useful if the consumer endeavors to order take out or actually eat at the restaurant.

The consumer next selects from a variety of submenus pertaining to the Location menu 52. In this example, the consumer may select one of a variety of countries from a Country submenu 64. The telephone search and corresponding software application are both compatible for use worldwide. Therefore, all communication with any aspect of either an online or offline telephone search will be available in multiple languages. The telephone search engine may provide language translation for voice or text transmission. Furthermore, the consumer may have the option to skip the Location menu 52 altogether if the consumer is using a traceable landline telephone, GPS enabled cellular-based telephone, or any other telephone where the telephone search engine automatically locates the position of the consumer. This function may also be available offline when using the software application. The automatic location recognition feature can be easily bypassed or turned off if the consumer endeavors to search a category not within the consumer's current locale.

The consumer may have the option of selecting from a State submenu 66 or a Zip Code submenu 68 if the consumer is not automatically located. If the consumer in the present example selects the United States as the applicable country, then the consumer may further search within the Location menu 52 by state and city or by zip code. Assume for this example that the consumer endeavors to find a restaurant in a nearby city. After country selection, the consumer selects a specific state and corresponding city name pursuant to the State submenu 66 and a City submenu 70. This categorical search function narrows the results of potential providers to within the desired area.

Next, the consumer then has two options in this example. In one embodiment, the consumer may connect directly to the telephone routing system 30 to obtain a real-time connection with a provider 32. Alternatively, the consumer may continue to narrow the categorical search criteria by accessing a variety of other searchable menus and submenus. As shown in FIG. 3, the consumer may choose to narrow the search by the Rating menu 56. The Rating menu 56 includes a variety of submenus that might include a User Ratings submenu 72, a System Ratings submenu 74, a Professional Ratings submenu 76, or a Cost Ratings submenu 78. The User Ratings submenu 72 includes a feature where consumers can access provider performance as rated by other consumers. Consumers may have an option to rate provider performance by answering a set of questions after a consultation. These ratings are calculated and stored by the telephone search engine system administer. Consumers may rate any provider in the telephone search engine system. Ratings may be associated to specific provider or consumer accounts. Such accounts and rating systems are available via the telephone search engine or may be available through an internet account or other quality control mechanism known in the art. The software application catalogs and updates user rating information regularly to provide an accurate provider rating system.

Additionally, the System Ratings submenu 74 might rate providers based on a set criteria or one or more algorithms developed by to the telephone search engine administrator. For example, the system administrator may create a rating system based on availability, call duration, complaints, positive feedback, frequency of consumer requests, popularity, years in business, etc. This is simply a short list of many potential criteria. The system administrator could also score and weigh each of these criteria relative to one another. The system administrator might assess an additional cost or lower a bid amount of specific low quality providers. For example, to receive the top bid, a provider may normally need to bid $7.00, but a low performing provider may need to bid $8.00 to receive the same top bid ranking. Alternatively, a popular or high quality provider may only need to bid $6.00 for the same ranking. The quality rating of the provider may change with consumer feedback or other quality control methods. As part of a feedback system incorporated in the present invention, consumers may send or receive any form of electronic communication via telephone, before, during, or after the real-time connection with the provider.

The Professional Ratings submenu 76 might include a series of peer related ratings. Peer ratings might be specific to the industry of a specific provider. These ratings could originate from professional organizations, discipline or awards from peers within the community, recognition from within the practice on a state, local, or national level.

Moreover, the Cost Ratings submenu 78 might include information regarding the cost of individual providers. In this embodiment, the consumer could select from a variety of providers within a given expense range.

In another aspect of the invention, the consumer is not disconnected entirely from the telephone routing system. For example, after the real-time connection with the provider 32 ends, the consumer may be asked to provide quality feedback concerning the provider. Alternatively, the consumer may have the ability to select another provider from the same search category. This method is similar to an internet search results page, where the consumer could select the next provider link on the page. Moreover, the consumer could choose to restart the telephone search or select a different menu or submenu. Most notably, the consumer is not completely disconnected from either the telephone search engine or the telephone routing system. Once disconnected, any information concerning the search, connection with the provider, feedback, or any other information stored or relayed during the use of the software application or the online telephone search engine may be transmitted to the consumer or provider by a text message, SMS, or any other form of communication described herein.

Continuing again with the present example, the consumer could search for a four-star rated restaurant from the Restaurant submenu 60 and the User Rating submenu 72 within the specific geographical location specified under the Location menu 52. The consumer is then connected to the telephone routing system 30 if this narrowed search category is satisfactory. The software application communicates the set of criteria selected and described above to the telephone routing system 30. The telephone routing system 30 eventually provides the consumer with a real-time connection with an appropriate provider 32.

In an alternative embodiment of FIG. 3, the consumer searches the Doctor submenu 62 and may select either a Phone Consultation submenu 80 or an Examination submenu 82. For example, the Doctor submenu 62 may include a list of doctors by practice: allergist, cardiologist, dermatologist, immunologist, pediatrician, etc. This initial menu filters the consumer search to doctors knowledgeable in a particular practice. The consumer may want to consult with a doctor due to an ailment, for education, or any other reason. If the consumer selects the Phone Consultation submenu 80, the location of the doctor may be of little importance or even inconsequential. Therefore, in this example, the consumer is taken to the Ratings menu 56 to select a doctor from among the remaining categories. Alternatively, the consumer may select the Examination submenu 82. Here, the location of the doctor is important as the consumer endeavors to find a doctor for an actual physical examination. Accordingly, the consumer is taken to the Location menu 52 and associated submenus.

One key aspect of the present invention is that the telephone search engine provides a direct connection to a specific category. Unlike internet search engines, the telephone search engine narrows the list of potential matching providers based on consumer search criteria. This significantly increases the quality of the eventual connection. Ultimately, the consumer is connected in real-time to a provider offering the item searched for by the consumer. Moreover, this process significantly reduces the time consumers spend searching, reading, and researching potential providers or items. Additionally, any one of a number of different rating systems built into the telephone search engine provide quality control to maintain the integrity, quality, and reliability of the telephone search engine service. The system administrator may also regulate quality by changing provider availability through the telephone routing system 30.

FIG. 4 is an alternative flowchart illustrating individual branches for selecting a searchable category. This embodiment discloses a process for searching for a celebrity. The consumer conducts the consumer telephone search 10 through the offline telephone search 20 via the software application. First, the consumer must select the Celebrity main menu 84. The Celebrity main menu 84 is not necessarily the only menu available via the software application. Many different menus may be included as part of the offline telephone search 20. Next, the consumer may select from a Film menu 86, a Music menu 88, or an Athlete menu 90. The scope and number of the submenus should not be limited thereto. FIG. 4 is merely a sample embodiment of the present invention. In one embodiment of FIG. 4, the consumer may desire to connect in real-time to a film star. The consumer first selects the Film menu 86. Here, the consumer may have the option of selecting from a Movie submenu 92, a TV Show submenu 94, or, if the consumer knows the actual name of a specific film star, the consumer may search by a Name submenu 96. Additionally, the Movie submenu 92 might be searchable according to a Genre submenu 98 and the Name submenu 96 might be searchable by an Alphabetical submenu 100. The telephone search engine displays a list of film stars 102 within the specific search category selected by the consumer under the Film menu 86. Celebrity listing 104, from the list of film stars 102, determines whether the consumer is directed to the telephone routing system 30 or to the online telephone search 38. If the consumer selects a listed celebrity, the software application goes online and connects the consumer directly to the telephone routing system 30. The telephone routing system 30 then checks for celebrity availability 106. Accordingly, a real-time connection 32 is formed if the celebrity is available and accepts the call.

If the celebrity listing 104 does not produce the desired celebrity within the list of film stars 102, the consumer may access the online telephone search 38 to conduct an extensive celebrity search. The online telephone search 38 has a real-time current celebrity list 108. It is possible that a new celebrity signed up for or was added to the telephone search engine since the consumer last updated the software application. Conducting the online telephone search 38 will access this real-time information. The online telephone search 38 processes the celebrity category requested by the consumer and provides, in this example, the current celebrity list 108. Alternatively, the online telephone search 38 may provide additional menus and submenus from which the consumer may select. If the celebrity is listed, the consumer is connected to the telephone routing system 30 to determine celebrity availability 106. A real-time connection 32 is made with the celebrity if the celebrity is available and accepts the call.

In another aspect of the present invention, providers have the option to accept or reject calls through the telephone routing system 30. The provider, a celebrity in the example in FIG. 4, may hear some information about the connecting consumer and decide whether to accept or reject the call. Thereby the provider always has the option of rejecting unwanted calls.

In an alternative embodiment, the consumer may search for a musician by selecting the Music menu 88 from the Celebrity main menu 84. The Music menu 88 lists a series of additional search criteria. In this embodiment, the consumer can search for musicians by gender through a Male submenu 110 or a Female submenu 112. After selecting a gender, the consumer might further narrow the celebrity search by selecting from a series of submenus including an individual or grouped Alphabetical Letter submenu 114. For example, the Alphabetical Letter submenus 114 might include individual letters like “A”, “B”, “C”, etc. organized by first name, middle name, last name, or nickname within the industry. Further, celebrities might be grouped in a range of letters such as “A-C”, “D-Ga”, “Ga-P”, etc. To search for a celebrity having the last name “Smith”, the consumer would select an “S” submenu 116 as shown in the sample embodiment of FIG. 4. After selecting the “S” submenu 116, the software application displays a list of musicians 118 within the selected consumer search category. If the desired celebrity is listed 104, the software application goes online and connects the consumer to the telephone routing system 30 for eventual real-time connection 32. Otherwise, the consumer is directed to the online telephone search 38.

In another alternative embodiment in FIG. 4, a consumer may endeavor to connect with an athlete. First, the consumer selects the Athlete menu 90 from the Celebrity main menu 84. The consumer has the option to choose from several different submenus including a Name submenu 120, a Sport submenu 122 and a Team submenu 124. From these categories, a consumer can connect with a specific athlete based on name, one of several athletes from a specific team, or any one of several athletes from a specific sport. A consumer search via the Sport submenu 122 or the Team submenu 124 will not necessarily list specific athletes, but rather list corresponding groups of athletes within each respective category.

In one embodiment, the consumer may connect with any one of several different athletes from within a broader category. For instance, the consumer may wish to connect with an athlete that played for the Chicago Bears football team. Menu selection includes choosing the Celebrity main menu 84, Athlete menu 90 and the Team submenu 124. Within the Team submenu 124, the consumer then selects the Chicago Bears. Here, a list of athletes 126 within the category may include any variety of current or former Chicago Bears players. A specific player or narrow group of players is not necessarily listed. Although, it is conceived that the consumer could continue to narrow selection criteria by, for example, year, position, statistics, etc. Again, the extent of potential search menu configurations within the scope of the present invention is virtually limitless. If the “Chicago Bears” are in the celebrity listing 104 within the list of athletes 126, the software application goes online and connects the consumer to the telephone routing system 30. The telephone routing system 30 then facilitates the real-time connection 32 between the consumer and a provider, here a specific athlete, based on the search criteria and celebrity availability 106. In this example, the telephone routing system 30 connects the consumer to any one of a number of Chicago Bears athletes available to take the call. A real-time connection 32 between the consumer and a Chicago Bears athlete is formed thereafter. Accordingly, this categorical search method is applicable to any one of a number of different searchable categories, including all categories disclosed herein.

In any one of the previous embodiments of FIG. 4, if the celebrity or group (e.g. “Chicago Bears”) does not appear as a listed celebrity 104, the consumer may go online and conduct the online telephone search 38. The online telephone search 38 contains a larger list of menus, submenus and potential searchable categories. In the example of FIG. 4, the online telephone search 38 may include a more comprehensive list of celebrities and searchable celebrity categories. If the current celebrity list 108 in the online telephone search 38 does not list the celebrity, the consumer receives an unspecified category message 128. The consumer has the option of starting a new consumer telephone search 10 or exiting the program 130 during the search again step 132.

Alternatively, if the current celebrity list 108 lists the celebrity, the consumer is directly connected to the telephone routing system 30. If the celebrity is available 106, the consumer and celebrity are connected in real-time 32 via any communication method known in the art. Alternatively, if the celebrity is unavailable or unwilling to connect with the consumer, the consumer receives an unavailable message 134. Again, during the search again step 132, the consumer may start a new consumer telephone search 10 or choose to exit the program 130. The new consumer telephone search 10 may be conducted offline with the software application or online as previously disclosed. The consumer may search for another celebrity or search within a completely different category according to the selectable main menus. If the consumer decides not to conduct another search, the telephone search engine goes offline and the consumer exits the program 132.

In any of the above embodiments, if the consumer receives a message from the telephone routing system that a provider is unavailable, the consumer is asked to start a new search. The consumer may start the new search or exit the program. Accordingly, the consumer may cancel any search by simply exiting the software application or disconnecting from the telephone network.

Additionally, the telephone search engine is keyword searchable—similar to an internet search engine. For example, the consumer may say or type, via text messaging, SMS, etc., the name of a celebrity. This keyword function automatically locates an appropriate searchable category. Categories might include a specific group of providers or any other searchable category herein disclosed. Alternatively, the keyword function could automatically locate a specific provider, such as a specific celebrity (e.g. Barbara Streisand). The breadth of the keyword search would be similar to that of doing an internet-based search using a search engine such as Google, MSN or Yahoo!. Moreover, the keyword search and search categories are combinable in a hybrid search. In one embodiment, the consumer selects a searchable category and thereafter further narrows the search within that specific category by conducting a keyword search. Alternatively, the consumer conducts a keyword search and selects any one of a number of different searchable categories listed as part of the keyword search results. For example, a consumer may a search for a car in an automobile category. The consumer then conducts a keyword search within the automobile category to search for a specific car. The keyword search may encompass year, make, model, or any other term that describes an automobile.

Referring back to FIG. 1, if the consumer selects an offline search category 28 that satisfies the search criteria, the consumer is connected to that category within the telephone routing system 30. From the software application, the consumer is preferably automatically routed within the telephone routing system 30 via DTMF signals. DTMF signals use a set of tones to automatically route consumers through the category of menus in the telephone routing system 30. The DTMF signals can be encrypted or compressed. Huffman coding is one method of encrypting and compressing the DTMF signals. Huffman coding uses variable length numerical code tables organized by the estimated probability of occurrence of a specific character. Shorter numerical codes are assigned to frequently occurring characters and longer numerical codes are assigned to infrequently occurring characters. Huffman coding is merely a preferred method of encrypting and compressing the DTMF signals. Other encryption and compression methods known in the art are also compatible with the present invention. Since the consumer already selected a particular searchable category using the software application offline, communication of the necessary DTMF signals pertaining to the particular searchable category within the telephone routing system 30 is automatic and nearly instantaneous. The software application automatically inputs the necessary DTMF signals to the telephone routing system 30.

The DTMF signals are only one example of several communication and routing tools used by the software application in connection with the telephone routing system 30. The DTMF signals are highlighted only as a preferred embodiment. In place of the DTMF signals could be other voice, word, number, letter, short message service (SMS), or other text messaging transmission that accomplishes the same routing process as the DTMF signals. In essence, the DTMF signals as used with the present application are one method of locating an address within the telephone routing system 30. In an alternative embodiment, a text message, SMS message, or other text based message is sent to the telephone routing system 30 before the consumer connects thereto via a telephone network. The telephone routing system 30 then initiates a telephone network connection with the consumer based on the information in the text message. The consumer is instantly connected to the appropriate search category as the telephone routing system 30 already received the consumer search data information via text. Thus, the consumer does not have to wait for data transmission while connected to the telephone routing system 30 via a telephone network connection.

For example, addresses in the telephone routing system are similar to an internet protocol (IP) address on the Internet. For instance, the web site Google.com is accessible via hyper text transfer protocol (HTTP) by entering the character string “www.google.com” or by entering the numerical string “216.239.37.99” as an IP address. Either entry into an internet enabled web browser routes users to the Google home page. A computer extracts the text in the character string “www.google.com” so that a domain name server may map the character string with the correct IP address, “216.239.37.99” in this example. Similar mapping occurs in the telephone search engine of the present invention. From the example in FIG. 3, the DTMF sequence for obtaining all “Spanish Restaurants” within “Los Angeles, Calif.” that have a “Four Star” “User Rating” might require entry of the following number sequence into a touch-tone telephone: “2”, “5”, “1”, “23”, “56”, “2”, and “4”. In this example, a hard pause (“ppp”) is inserted after the phone number is dialed and is followed by entry of the following numerical sequence “2”, “5”, “1”, “23”, “56”, “2”, and “4”. If the telephone number of the telephone routing system 30 is “123-456-7890”, then the location of the above described category within the telephone routing system 30 is “1234567890ppp ‘2’, ‘5’, ‘1’, ‘23’, ‘56’, ‘2’, ‘14’”, wherein the “ppp” represents a hard pause (e.g. a 3-6 second delay). The system processes the numerical entries entered after the hard pause by decompressing the associated DTMF signals. This numerical string is the address of a specific search category within the telephone routing system 30. These addresses are preferred static so that consumers can store and retrieve frequently searched categories via speed dial. Although dynamic telephone addresses are also within the scope of the present invention.

Similarly, the telephone search engine also uses text and voice commands to connect consumers with specific search categories. The telephone search engine can convert between numerical string based addresses (like the Google IP address “216.239.37.99”) and character string based addresses (like the Google character string “www.google.com”). In the previous example, the telephone search engine may also map the letters in the following character string “1234567890ppp ‘Restaurant’, ‘Spanish’, ‘United States’, ‘California’, ‘LosAngeles’, ‘UserRating’, ‘FourStar’” (or similar SMS character string) to the corresponding numerical string “1234567890ppp ‘2’, ‘5’, ‘1’, ‘23’, ‘56’, ‘2’, ‘4’”. The character string and numerical string correspond to the same search category. Alternatively, search categories may be associated with specific numerical classes. For example, the Spanish Restaurants category in the previous example may be arbitrarily located in a DTMF numerical class “0001”. An associated Italian Restaurant category having the same or similar qualifications may reside in the numerical class “0002”. These shorter numerical classes merely compartmentalize the location of each search category within the telephone search engine. In this example, the Spanish Restaurant category would be mapped to “1234567890ppp0001”. Hence, the telephone search engine is capable of mapping specific search criteria, via a character string created from a keyword or category search, to an otherwise arbitrary numerical class as previously described. Such mapping is similar to an internet browser that extracts the text from a character string and passes it to a domain server, wherein the domain name server matches the character string to a specific IP address (numerical class). Hence, voice commands, text messaging, SMS, and touch-tone dialing are all able to locate the same specific search categories.

In an alternative embodiment, a hybrid offline and online telephone search engine search is conducted. Part of the category search is conducted offline via the software application and the other part of the category search is conducted online through the online telephone search engine search 38. In this embodiment, the address will locate a specific search category having broader scope. Thereafter the consumer continues to narrow the searchable category online.

FIG. 1 illustrates an alternative embodiment of the present invention where the consumer conducts an online telephone search 38. The online telephone search 38 is conducted when the consumer is unable to find an offline search category 28 that satisfies the search criteria, the consumer does not otherwise have a programmable telephone device 16, or when the consumer desires to use another search method other than the software application. The online telephone search 38 incorporates a set of menus in a similar manner as the software application. As previously described, the online telephone search menus are more extensive and contain more information than the software application. The difference in information is due largely to the desirable small size of the software application menus and submenus. Additionally, the online telephone search 38 enables any consumer having telephone access, and not necessarily a programmable telephone device 16, to access the telephone search engine of the present invention. In this embodiment, the consumer accesses the telephone search engine from any one of a number of different telephonic devices, including a landline telephone, VoIP telephone, or even a pay telephone. The online telephone search 38 can recognize calling areas by tracing landline call origination, by locating cellular phone signals via GPS or another geolocation technology known in the art. Longitudinal and latitudinal coordinates are sent to the telephone search engine to facilitate automatic selection of location specific categories. Consumers may easily turn off this feature if desired. Upon going online the consumer may be prompted to search within that particular locale, or choose to go to the main menu.

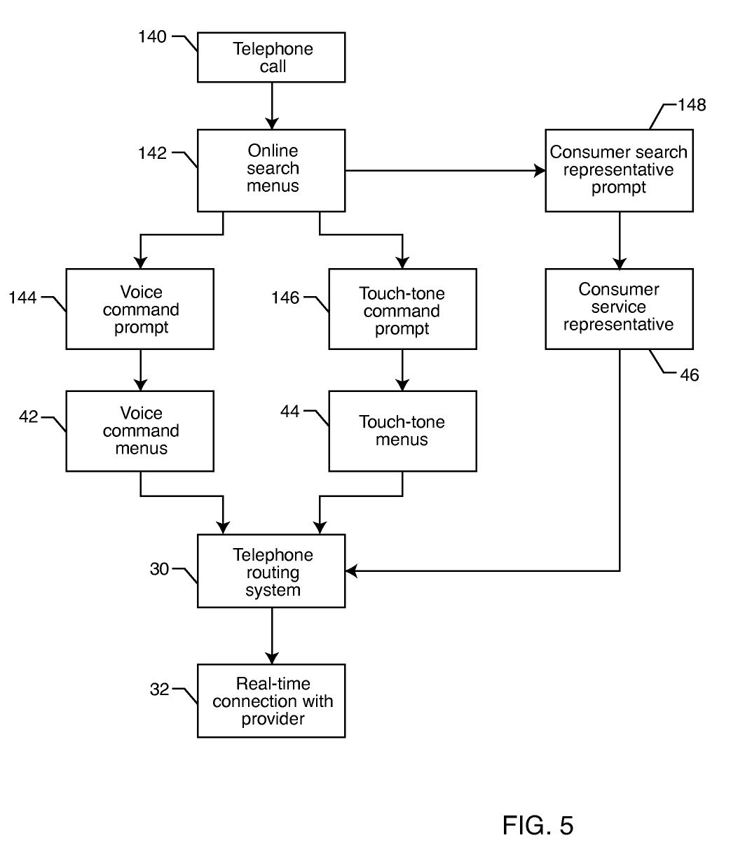

The consumer may utilize a variety of search methods as part of the larger online telephone search 38. In one embodiment, the consumer conducts a real-time search using the software application as previously described. Additionally, FIGS. 1 and 5 illustrate three other alternative methods for conducting the online telephone search 38. These three embodiments are particularly preferred when the consumer does not have a programmable telephone device 16. As shown in FIG. 5, the consumer first places a telephone call 140 to access the online telephone search 38. Placing a telephone call 140 involves going online and connecting to a telephone network. It is particularly preferred that one telephone number provides access to all aspects of the telephone search engine. Although multiple telephone numbers could be used in conjunction with different, specialized services, such as auctions, real estate, travel, etc. Preferably this telephone number is a toll free (800) number, a local access number, or a telephone carrier defined number such as a 611 or a 411 number, such that the consumer does not incur additional air time expenses.

The consumer is presented with a set of online search menus 142 after initiating the telephone call 140. In one embodiment, the consumer searches the online telephone search engine menus using the voice commands 42. For instance, the consumer may receive a voice command prompt 144 wherein the consumer may say “voice” if the voice command menus 42 are desired. Alternatively, the consumer may just speak to the telephone search engine to initiate the voice command menus 42, without prompting. The system will recognize a request for “Hotels”, for example, and ask further questions or provide searchable categories to narrow the scope of the search. The consumer simply answers the questions by speaking into the telephone. The online telephone search engine is configured to recognize multiple languages for worldwide use. Accordingly, the online telephone search engine is capable of conveying instructions and menu choices in each respective consumer language.

If the consumer says “voice” or otherwise initiates the voice command prompt 144, the consumer steps through the voice command menus 42 to locate a searchable category. For example, in response to “Hotels”, the consumer may be asked to specify a city. The consumer could respond “Los Angeles”. The voice recognition system would take the user directly to the Los Angeles submenu. The system may ask another question, list the available search categories, or provide more narrowing submenus. This process continues until a suitable searchable category is reached. The consumer may also search broader categories by saying “search” at any point within the menu or submenu selection process. Alternatively, the online search engine may provide the consumer with a list of selectable categories. When the consumer reaches a desirable category, the consumer could indicate selection by repeating the name of the category or saying “select”.

In another alternative embodiment of FIG. 5, the consumer navigates the online search menus 142 with the touch-tone menus 44. Again, the method of selecting a search category is similar to the menus and submenus in the software application and the voice command menus 42. But, in this embodiment, consumers must listen for each individual menu option. For example, the consumer may receive a touch-tone command prompt 146 to access the touch-tone menus 44 by pressing the number “1” on a numerical keypad. Navigating through the menus and submenus is accomplished via the numerical key pad on the touch-tone telephone. As previously described, consumers may store frequently used search categories that have static addresses in speed-dial. Speed-dial access eliminates air time associated with repeated searching for a particular category. Additionally, an LCD mounted to the telephone could display a list of menu and submenu options. The consumer could listen to each option or select a menu or submenu based on the contents shown on the LCD display. In another embodiment, the consumer may select a particular menu directly by selecting the desired menu from a touch sensitive LCD screen.

In the previous examples for the voice command menus 42 and the touch-tone menus 44, the consumer selects searchable categories by interacting with a voice command or touch-tone command electronic interface system. The telephone search engine accordingly catalogs each consumer menu and submenu selection. When the consumer reaches a satisfactory category, the telephone search engine connects to the telephone routing system 30. Thereafter, the consumer is routed within the telephone routing system 30 by any of the methods disclosed herein, including the preferable DTMF signals. The catalog of menu and submenu selections are automatically entered into the telephone routing system 30 for placement in a category that eventually connects the consumer to a provider in real-time. The telephone search engine easily and quickly navigates the consumer through the selectable menus in the telephone routing system 30 to arrive at the real-time connection 32 with a provider.

In another embodiment of FIG. 5, the consumer may receive a consumer search representative prompt 148. Here the consumer may dial “0” to connect directly to the consumer search representative 46. The online telephone search 38 is conducted in collaboration with the consumer search representative 46. Here, the consumer can explain the certain aspects or qualities of the desired search criteria. Communication with the consumer search representative 46 can be by voice, text, chat, or any other form of electronic or personal communication known in the art. The consumer search representative 46 then selects an appropriate search category according to the desired search criteria. The consumer is thereafter directly connected to the telephone routing system 30 by the consumer search representative 46. As illustrated in FIG. 5, the DTMF signals are not necessarily required when connecting to the telephone routing system 30 via the consumer search representative 46. The consumer search representative 46 has direct access to the desired search category. Although, the consumer service representative 46 may use a system that catalogs the search category selections via the DTMF signals, similar to the voice command menus 42 and the touch-tone menus 44. Thus, connection to the telephone routing system 30 may use the DTMF signals or other comparable routing process disclosed herein.

The telephone search engine is also customizable based on consumer need. Consumers can customize various search options, menus, submenus, etc. within the software application or within the online telephone search. Personalized consumer data is stored via unique telephone numbers, account numbers, user name/passwords, or other unique consumer information. The telephone search engine may also store consumer specific information such as an address book or other provider contact information. Information is transferred to the telephone search engine via file transfer protocol (FTP) or another electronic data transfer method known in the art. This contact information is searchable such that the telephone search engine can use the information to create a connection between a consumer and a provider. In one sample embodiment, customized account information is particularly preferred if the consumer endeavors to connect to a doctor. Medical history and pertinent health related information can be stored locally in individual accounts. Alternatively, such information could be stored remotely by a third party and be accessible for viewing or listening by a doctor. Of course, the consumer must first authorize the release of any information. Alternatively, the consumer may need to fill in basic medical information and medical history over the telephone before connecting to the telephone routing system 30 or before obtaining the real-time connection with a provider 32. In another aspect of the present invention, doctors may prescribe medications over the telephone. These prescriptions can be stored by a medical facility, third party administrator, or the telephone search engine user database. Accordingly, the consumer receives the prescription via an electronic message such as a text message or email.

The telephone search engine can also bill a consumer directly through a consumer telephone carrier statement. Such billing is similar to traditional “900” call billing, but greatly expanded. Consider a consumer that consults with a doctor who charges an hourly consultation fee. Fees incurred by the consumer as part of the telephone consultation session may be billed to the consumer's telephone carrier statement. The bill is administered directly by the telephone carrier. This billing method alleviates any need for the doctor or other provider to bill the consumer directly.

In another embodiment, the consumer pays for “per-minute” consultation fees through a pay telephone. The connection and consultation is permitted to continue pending the consumer continues to pay at the pay telephone via change, calling card credits, credit card, etc.

Consumers are also able to place classified advertisements through the telephone search engine. Persons searching for “used cars” might access a variety of searchable menus in the telephone search engine pertaining to make, model, year, miles, location, etc. Purchases, sales, and any other charges or credits may also be handled through the consumer telephone carrier statement. This enables consumers to easily search for and purchase merchandise through the telephone search engine. Providers may also set up such accounts to facilitate debits and credits. In another alternative embodiment, consumers use the telephone search engine to participate in real-time auctions. Consumers place bids over the telephone search engine. Again, charges and credits are applied to consumer or provider telephone carrier statements.

Consumer billing varies depending on the item purchased or sold by the consumer or provider. In previously described embodiments, the consumer connects to a doctor or celebrity for a real-time, on-demand telephone conversation. The doctor or celebrity may have a per-minute fee or flat fee chargeable to the consumer. The celebrity or doctor pays a telephone routing system administrator a base fee (or a bid fee according to U.S. Pat. No. 7,076,037) for the quality lead. Providers, such as persons placing classified advertisements, hotels that bid for leads, or any other provider as broadly described and defined above only pay the telephone routing system administrator this base fee in exchange for the real-time connection with a consumer. Classified advertisements, for example, are otherwise free. The provider placing the advertisement pays for the connecting telephone call only. The base fee could represent a percentage of the item sold, e.g. one-quarter percent (¼%) or a flat fee such as 50 cents per telephone call. Fees will vary depending on the industry and item.

Alternatively, consumers may charge goods or services, such as hotel reservations, directly to a telephone carrier statement. The hotel pays a base or bidded fee to receive the telephone call lead of an actual consumer endeavoring to purchase the hotel's services. The base or bidded fee is almost certainly redeemable by the hotel via the consumer's purchase of hotel services. The telephone routing system facilitates the process of connecting the consumer, through the process previously described, to a hotel that has available rooms matching the consumer's search criteria. The consumer to provider matching process saves time and money of both the consumer and provider. The consumer is immediately connected to a provider without undue searching. The provider is immediately connected to a consumer endeavoring to purchase the provider's services. The provider does not waste unneeded time receiving inquiries from consumers not endeavoring to retain the hotel's services, whether by accident or lack of information.

Furthermore, individual consumer accounts are also usable in conjunction with a profit sharing plan. In one embodiment, consumers receive refunds for using services via the telephone search engine. For example, if a doctor pays $7.00 to the telephone routing system administrator to list a $2.00/minute consulting service, the consumer may receive a portion of the $7.00 pursuant to the profit sharing plan. Additionally, the telephone carrier, such as Verizon, AT&T, Cingular, etc. could also receive a portion of each fee. These fees are billable and refundable directly via the consumer telephone carrier statements as previously described. Instead of receiving several different bills for multiple consultation sessions and multiple refunds as part of the profit sharing plan, the consumer would, instead, receive one monthly statement from the telephone carrier detailing all credits and debits. In essence, the consumer could use the telephone carrier statement as a wallet, credit card, etc.

The telephone search engine of the present invention basically has the breadth of any internet search engine. The administration of such a search in view of the present invention is conducted more accurately and over a telephone network connection. The telephone search engine is also capable of saving information concerning consumer searches. This information is stored and associated with a specific consumer via any of the aforementioned identification methods. The telephone search engine is therefore capable of suggesting searchable categories when the consumer conducts future searches. Accordingly, the telephone search engine learns and adapts to the specific needs of individual consumers. Additionally, the telephone search engine can automatically create categories pertaining to frequently searched terms.

While the online telephone search 38 is updated in real-time, it is also possible to update the software application. Updates to the software application may add new categories, delete old or unused categories, change the arrangement of the menus, or provide necessary updates for compatibility as technology evolves. Updates to the software application are available in several ways including, but not limited to, data transfer over a telephone network connection, MMS, an internet connection, or any other form of electronic communication known in the art.

Although several embodiments have been described in some detail for purposes of illustration, various modifications may be made to each without departing from the scope and spirit of the invention. Accordingly, the invention is not to be limited, except as by the appended claims.

What is claimed is:

1. A process for facilitating a telephone-based search, comprising the steps of:
accepting a telephone inquiry;
receiving search criteria through the telephone inquiry;
searching an electronic database for information relevant to the search criteria;
conveying a search result relating to the search criteria in response to the telephone inquiry; and
routing the telephone inquiry to a third party associated with the search result.

2. The process of claim 1, wherein the receiving step includes the step of receiving at least a portion of the search criteria from a software application on a telephone.

3. The process of claim 2, wherein at least a portion of the electronic database is stored on the telephone and is searchable by the software application.

4. The process of claim 1, wherein the search result comprises a searchable category, the third party, or a list of selectable third parties.

5. The process of claim 4, including the step of ranking the list of selectable third parties in the search result.

6. The process of claim 5, including the steps of geographically locating the origination of the telephone inquiry and ranking the list of selectable third parties based on the geographic location of the third parties relative to the location of the telephone inquiry.

7. The process of claim 5, including the step of re-ranking the list of selectable third parties based on additional search criteria provided through the telephone inquiry.

8. The process of claim 1, wherein the search criteria comprises a keyword or a category.

9. The process of claim 8, including the step of narrowing the search by the category.

10. The process of claim 1, wherein the receiving step includes the step of receiving the search criteria by voice, text message, SMS, DTMF, a search representative, a touch-tone or a software application on a telephone.

11. The process of claim 1, wherein the conveying step includes the step of communicating the search result by voice, text message or a software application.

12. The process of claim 1, including the step of updating the electronic database in real-time.

13. The process of claim 1, including the step of transferring a search engine software application to a telephone.

14. The process of claim 1, including the step of querying a telephone for determining whether a search engine software application is installed on the telephone.

15. The process of claim 1, wherein the accepting step includes the step of establishing a data connection with a telephone over a telephone network.

16. The process of claim 1, wherein the routing step includes the step of routing the telephone inquiry to the third party on-demand and in real-time.

17. The process of claim 1, including the step of establishing a universal access number for accepting the telephone inquiry.

18. A process for facilitating a telephone-based search, comprising the steps of:
accepting a telephone inquiry;
receiving search criteria comprising a keyword or a category through the telephone inquiry, wherein at least a portion of the search criteria is received from a software application on a telephone;
searching an electronic database for information relevant to the search criteria;
conveying a search result relating to the search criteria in response to the telephone inquiry; and
routing the telephone inquiry to a third party associated with the search result.

19. The process of claim 18, wherein the search result comprises a searchable category, the third party, or a list of selectable third parties and at least a portion of the electronic database is stored on the telephone and is searchable by the software application.

20. The process of claim 19, including the steps of narrowing the search by geographically locating the origination of the telephone inquiry and ranking the list of selectable third parties in the search result based on the geographic location of the third parties relative to the location of the telephone inquiry and re-ranking the list of selectable third parties based on additional search criteria provided through the telephone inquiry.

21. The process of claim 18, wherein the receiving step includes the step of receiving the search criteria by voice, text message, SMS, DTMF, a search representative, a touch-tone or the software application on the telephone and the conveying step includes the step of communicating the search result by voice, text message or the software application.

22. The process of claim 18, including the step of updating the electronic database in real-time, wherein the routing step includes the step of routing the telephone inquiry to the third party on-demand and in real-time.

23. The process of claim 18, including the step of transferring the software application to the telephone after determining the software application is not installed on the telephone.

24. The process of claim 18, including the step of establishing a universal access number for accepting the telephone inquiry, wherein the accepting step includes the step of establishing a data connection with the telephone over a telephone network.

25. A process for facilitating a telephone-based search, comprising the steps of:
accepting a telephone inquiry;
receiving search criteria comprising a keyword or a category through the telephone inquiry;
searching an electronic database for information relevant to the search criteria;
conveying a search result comprising a searchable category or a list of selectable third parties relating to the search criteria in response to the telephone inquiry; and
routing the telephone inquiry to a third party associated with the search result.

26. The process of claim 25, including the step of updating the electronic database in real-time, at least a portion of the electronic database is stored on a telephone and is searchable by a software application installed thereon, wherein the routing step includes the step of routing the telephone inquiry to the third party on-demand and in real-time and the receiving step includes the step of receiving at least a portion of the search criteria from the software application on the telephone.

27. The process of claim 25, including the steps of narrowing the search by the searchable category and ranking the list of selectable third parties in the search result, wherein the accepting step includes the step of establishing a data connection with a telephone over a telephone network.

28. The process of claim 27, including the steps of:
geographically locating the origination of the telephone inquiry;
ranking the list of selectable third parties based on the geographic location of the third parties relative to the location of the telephone inquiry; and
re-ranking the list of selectable third parties based on additional search criteria provided through the telephone inquiry.

29. The process of claim 25, wherein the receiving step includes the step of receiving the search criteria by voice, text message, SMS, DTMF, a search representative, a touch-tone or a software application on a telephone and the conveying step includes the step of communicating the search result by voice, text message or the software application.

30. The process of claim 25, including the steps of:
querying a telephone for determining whether a search engine software application is installed on the telephone;
transferring the search engine software application to the telephone after determining the search engine software application is not installed on the telephone; and
establishing a universal access number for accepting the telephone inquiry.
